(19) United States
(12) Patent Application Publication
(10) Pub. No.: US 2016/0121246 A1
(43) Pub. Date: May 5, 2016

(54) METHOD AND DEVICE FOR REMINDING USER ABOUT SMART WATER PURIFIER

(71) Applicant: Xiaomi Inc., Beijing (CN)

(72) Inventors: Yun YANG, Beijing (CN); Ziguang GAO, Beijing (CN); Mingjun YIN, Beijing (CN)

(73) Assignee: Xiaomi Inc.

(21) Appl. No.: 14/844,079

(22) Filed: Sep. 3, 2015

Related U.S. Application Data
(63) Continuation of application No. PCT/CN2015/074512, filed on Mar. 18, 2015.

(30) Foreign Application Priority Data
Oct. 31, 2014 (CN) 201410602416.0

(51) Int. Cl. B01D 35/143

(52) U.S. Cl. CPC B01D 35/143

(57) ABSTRACT

A method for reminding a user about a water purifier includes receiving total dissolved solids (TDS) data reported by the water purifier, updating accumulative TDS data corresponding to the water purifier according to the received TDS data, calculating a cleaning period of the water purifier according to the accumulative TDS data and a preset maximum cleaning period, and sending a reminder message to a terminal associated with the water purifier to remind the user to clean the water purifier if the cleaning period satisfies a preset condition. The received TDS data is detected after the water purifier performs water purification and the accumulative TDS data reflects an accumulation of total TDS data of the water purifier since a latest cleaning.

### CROSS-REFERENCE TO RELATED APPLICATIONS

This application is a continuation of International Application No. PCT/CN2015/074512, filed Mar. 18, 2015, which is based upon and claims priority to Chinese Patent Application No. 201410602416.0, filed Oct. 31, 2014, the entire contents of both of which are incorporated herein by reference.

### TECHNICAL FIELD

The present disclosure relates to smart household appliances and, more particularly, to a method and device for reminding a user about a smart water purifier.

### BACKGROUND

Water purifiers are widely used nowadays in, for example, a residential or commercial environment. During the use of a water purifier, bacteria may enter into the interior of the water purifier through the filter membrane or the water outlet of the water purifier, thus contaminating the interior of the water purifier. As a result, a regular physical cleaning of the water purifier is required. Generally, water purifier manufacturers will include a cleaning period in the user manual to remind the user to clean the water purifier. Different cleaning periods can be set according to water qualities of different regions.

### SUMMARY

In accordance with the present disclosure, there is provided a method for reminding a user about a water purifier. The method includes receiving total dissolved solids (TDS) data reported by the water purifier, updating accumulative TDS data corresponding to the water purifier according to the received TDS data, calculating a cleaning period of the water purifier according to the accumulative TDS data and a preset maximum cleaning period, and sending a reminder message to a terminal associated with the water purifier to remind the user to clean the water purifier if the cleaning period satisfies a preset condition. The received TDS data is detected after the water purifier performs water purification and the accumulative TDS data reflects an accumulation of total TDS data of the water purifier since a latest cleaning

Also in accordance with the present disclosure, there is provided a method for reminding a user about a water purifier. The method includes acquiring total dissolved solids (TDS) data after the water purifier performs water purification and sending the TDS data to a server, so that the server sends a reminder message to a terminal associated with the water purifier according to the TDS data if a preset condition is satisfied.

Also in accordance with the present disclosure, there is provided a device for reminding a user about a water purifier. The device includes a processor and a non-transitory computer-readable storage medium storing instructions that, when executed by the processor, cause the processor to receive total dissolved solids (TDS) data reported by the water purifier, update accumulative TDS data corresponding to the water purifier according to the received TDS data, calculate a cleaning period of the water purifier according to the accumulative TDS data and a preset maximum cleaning period, and send a reminder message to a terminal associated with the water purifier to remind the user to clean the water purifier if the cleaning period satisfies a preset condition. The received TDS data is detected after the water purifier performs water purification and the accumulative TDS data reflects an accumulation of total TDS data of the water purifier since a latest cleaning.

Also in accordance with the present disclosure, there is provided a device for reminding a user about a water purifier. The device includes a processor and a non-transitory computer-readable storage medium storing instructions that, when executed by the processor, cause the processor to acquire total dissolved solids (TDS) data after the water purifier performs water purification and send the TDS data to a server, so that the server sends a reminder message to a terminal associated with the water purifier according to the TDS data if a preset condition is satisfied.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for reminding a user about a smart water purifier according to an exemplary embodiment.

FIG. 2 is a flow chart of a method for reminding a user about a smart water purifier according to another exemplary embodiment.

FIGS. 3A-3C are flow charts of a method for reminding a user about a smart water purifier according to another exemplary embodiment.

FIG. 4 is a flow chart of a method for reporting a cleaning event according to an exemplary embodiment.

FIG. 5 is a block diagram of a device for reminding a user about a smart water purifier according to an exemplary embodiment.

FIG. 6 is a block diagram of a device for reminding a user about a smart water purifier according to another exemplary embodiment.

FIG. 7 is a block diagram of a device for reminding a user about a smart water purifier according to another exemplary embodiment.

FIG. 8 is a block diagram of a device for reminding a user about a smart water purifier according to another exemplary embodiment.

### DETAILED DESCRIPTION

Exemplary embodiments of the present disclosure will be further described in details with reference to the accompanying drawings.

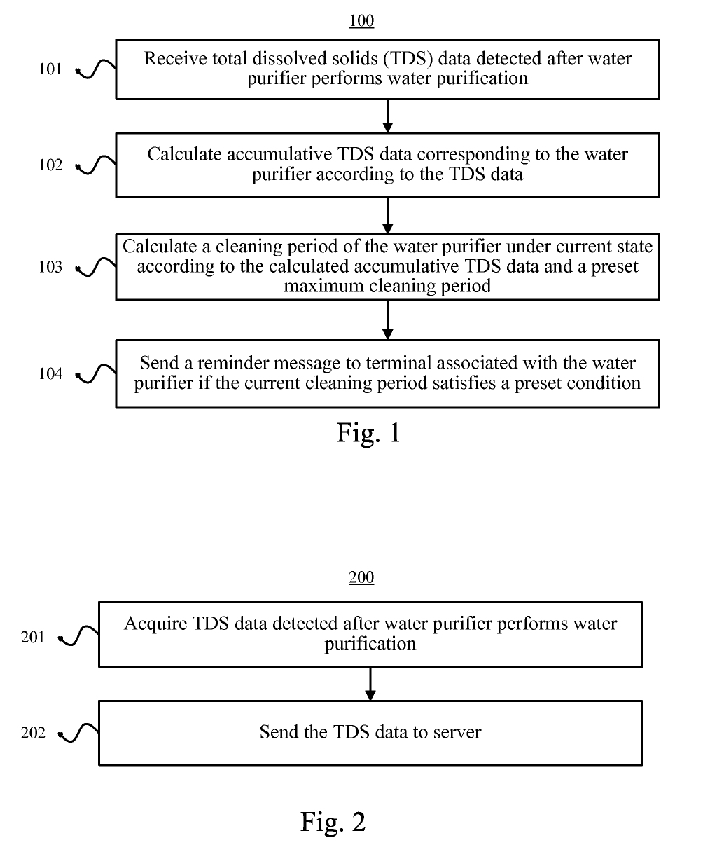

FIG. 1 is a flow chart showing a method 100 for reminding a user about a smart water purifier according to an exemplary embodiment of the present disclosure. The method 100 may be implemented in a server. As shown in FIG. 1, at 101, the server receives total dissolved solids (TDS) data detected after the water purifier performs water purification. TDS is also referred to as total amount of dissolved solids. The unit of TDS is milligram/litre (mg/L), which indicates how many milligrams of solids are dissolved in one litre of water. A higher TDS value represents more foreign matters contained in the water. Since the production of bacteria in the water purifier is mainly associated with time and cumulated foreign matter, the TDS data can be an indication of the need to clean the water purifier.

At 102, accumulative TDS data corresponding to the water purifier is calculated according to the TDS data. The accumulative TDS data represents a total increment of the TDS data from the water purifier since the latest cleaning

At 103, a cleaning period of the water purifier under the current state, which is also referred to as a “current cleaning period,” is calculated according to the calculated accumulative TDS data and a preset maximum cleaning period.

At 104, if the current cleaning period satisfies a preset condition, a reminder message is sent to a terminal associated with the water purifier to remind the user to clean the water purifier.

FIG. 2 is a flow chart showing a method 200 for reminding a user about a smart water purifier according to another exemplary embodiment of the present disclosure. The method 200 may be implemented in the smart water purifier. As shown in FIG. 2, at 201, TDS data detected after the water purifier performs water purification is acquired. At 202, the TDS data is sent to a server, so that the server sends a reminder message to a terminal associated with the smart water purifier according to the TDS data.

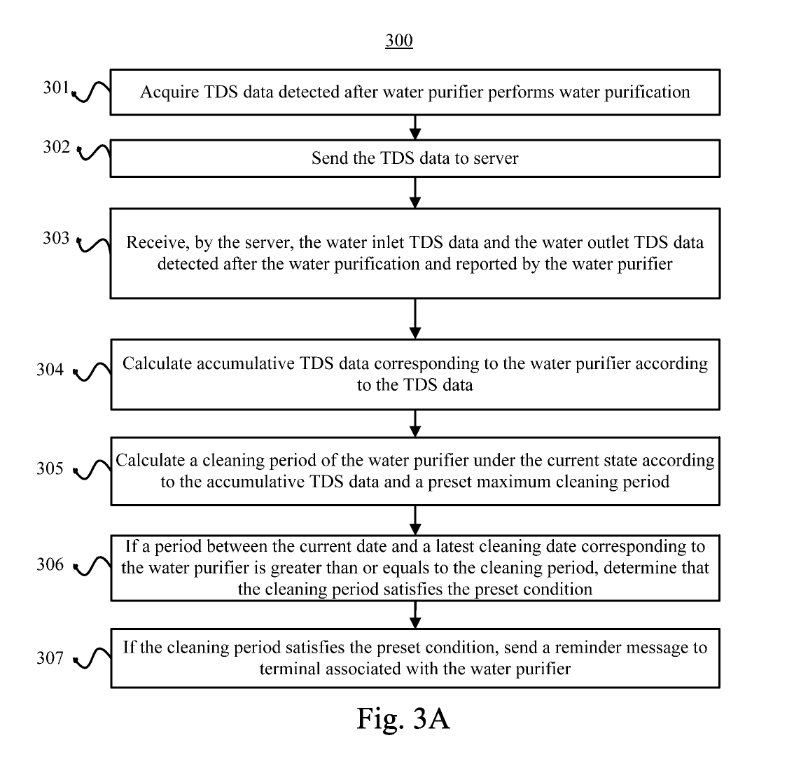

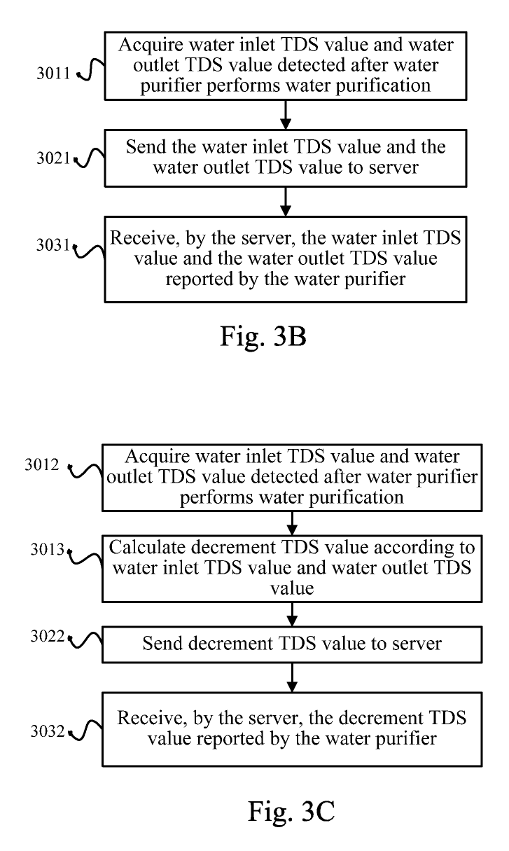

FIGS. 3A is a flow chart showing a method 300 for reminding a user about a smart water purifier according to another exemplary embodiment of the present disclosure. As shown in FIG. 3A, at 301, TDS data detected after the water purifier performs water purification is acquired.

In some embodiments, detection units are respectively arranged on a water inlet and a water outlet of the water purifier, and are configured to respectively detect the TDS at the water inlet and the TDS at the water outlet so as to obtain a water inlet TDS value and a water outlet TDS value. Since the water introduced from the water inlet into the water purifier is purified by the water purifier, after the water purifier performs water purification, the water outlet TDS value detected at the water outlet is usually smaller than the water inlet TDS value detected at the water inlet.

In some embodiments, the TDS data reported by the water purifier to the server may include both the water inlet TDS value and the water outlet TDS value, hereinafter referred to as “Scenario I.” In some embodiments, the TDS data reported by the water purifier to the server may include a decrement TDS value calculated by, for example, subtracting the water outlet TDS value from the water inlet TDS data, hereinafter referred to as “Scenario II.”

In Scenario I, acquiring the TDS data includes acquiring the water inlet TDS value and the water outlet TDS value detected after the water purifier performs water purification (3011 in FIG. 3B). In Scenario II, acquiring the TDS data includes acquiring the water inlet TDS value and the water outlet TDS value detected after the water purifier performs water purification (3012 in FIG. 3C) and calculating the decrement TDS value according to the water inlet TDS value and the water outlet TDS value (3013 in FIG. 3C).

In some embodiments, the TDS data can be reported to the server every time after the user uses the water purifier to perform water purification. Alternatively, the water purifier may record the TDS data required to be reported during each water purification and, when the number of usage reaches a preset number of times, report all TDS data corresponding to the preset number of times to the server. Moreover, the water purifier may record the TDS data required to be reported during each water purification and, when a preset period of time is reached, report all TDS data recorded within the preset period to the server.

Referring again to FIG. 3A, at 302, the TDS data is sent to a server, so that the server sends a reminder message to a terminal associated with the water purifier according to the TDS data.

In Scenario I, sending the TDS data includes sending the water inlet TDS value and the water outlet TDS value to the server (3021 in FIG. 3B). In Scenario II, sending the TDs data includes sending the decrement TDS value to the server (3022 in FIG. 3C).

Referring again to FIG. 3A, at 303, the server receives the TDS data detected after water purification and reported by the water purifier.

In scenario I, receiving the TDS data includes the server receiving the water inlet TDS value and the water outlet TDS value reported by the water purifier (3031 in FIG. 3B). In Scenatio II, receiving the TDS data includes the server receiving the decrement TDS value reported by the water purifier (3032 in FIG. 3C).

Referring again to FIG. 3A, at 304, accumulative TDS data corresponding to the water purifier is calculated according to the TDS data. The accumulative TDS data refers to a total TDS data increment from the water purifier since a latest cleaning.

A corresponding relationship between an identity of the water purifier and the accumulative TDS data is saved in the server, and the accumulative TDS data for each water purifier registered in the server after the latest cleaning of the water purifier is saved in the corresponding relationship.

In Scenario I, the server calculates the decrement TDS value according to the water inlet TDS value and the water outlet TDS value in the TDS data reported by the water purifier, and adds the calculated decrement TDS data to the accumulative TDS data corresponding to the water purifier.

In Scenario II, since the TDS data reported by the water purifier already includes the decrement TDS value, the server directly adds the decrement TDS value reported by the water purifier to the accumulative TDS data corresponding to the water purifier.

At 305, a cleaning period of the water purifier under the current state is calculated according to the accumulative TDS data corresponding to the water purifier and a preset maximum cleaning period.

According to the present disclosure, the cleaning period can be calculated each time after the accumulative TDS data is calculated, or be calculated at a preset time every day. In some embodiments, the cleaning period can be calculated as follows:

days=days_max−power(1+(Σday_dirt)/p2, p3);

where, days is the calculated cleaning period, days max is the preset maximum cleaning period, Σday_dirt is the total TDS data increment of the water purifier since the latest cleaning, p2 is a first preset constant, p3 is a second preset constant, and function power(a, b) calculates a to the b^{th} power, i.e., power(a, b) =a^{b}.

At 306, if the period between the current date and the latest cleaning date corresponding to the water purifier is longer than or equal to the cleaning period, the cleaning period is determined to have satisfied the preset condition.

For example, the current date is July 6, the latest cleaning date is July 1, and the calculated cleaning period is 10 days. The period between the current date and the latest cleaning date is 5 days, which is shorter than the cleaning period. In this case, the water purifier does not require cleaning at the current date and there is no need to send a reminder message to the terminal associated with the water purifier. The processes from 301 to 305 are repeated.

As another example, the current date is July 8, the latest cleaning date is July 1, and the calculated cleaning period is 7 days. The period between the current date and the latest cleaning date is 7 days, which equals the cleaning period. In this case, the water purifier needs cleaning at the current date and a preset condition of sending a reminder message has been satisfied.

At 307, if the cleaning period satisfies the preset condition, a reminder message is sent to the terminal associated with the water purifier to remind the user to clean the water purifier.

A correlation relationship between the identity of the water purifier and the identity of the terminal is pre-stored in the server. For example, the correlation relationship can be saved in the server when the water purifier is used and registered at the server for the first time.

The identity of the terminal is inquired according to the identity of the water purifier, and a reminder message is sent to the terminal according to the identity of the terminal to remind the user. The content of the reminder message may be, for example, “Excessive foreign matter has been accumulated in the water purifier. Please clean the water purifier soon.”

After a cleaning event is reported by the water purifier, the server resets the accumulative TDS data corresponding to the water purifier in the corresponding relationship between the water purifier and the accumulative TDS data, according to the identity of the water purifier reporting the cleaning event. As such, the TDS data can be accumulated again from the current time to determine a time period needed to clean the purifier next time.

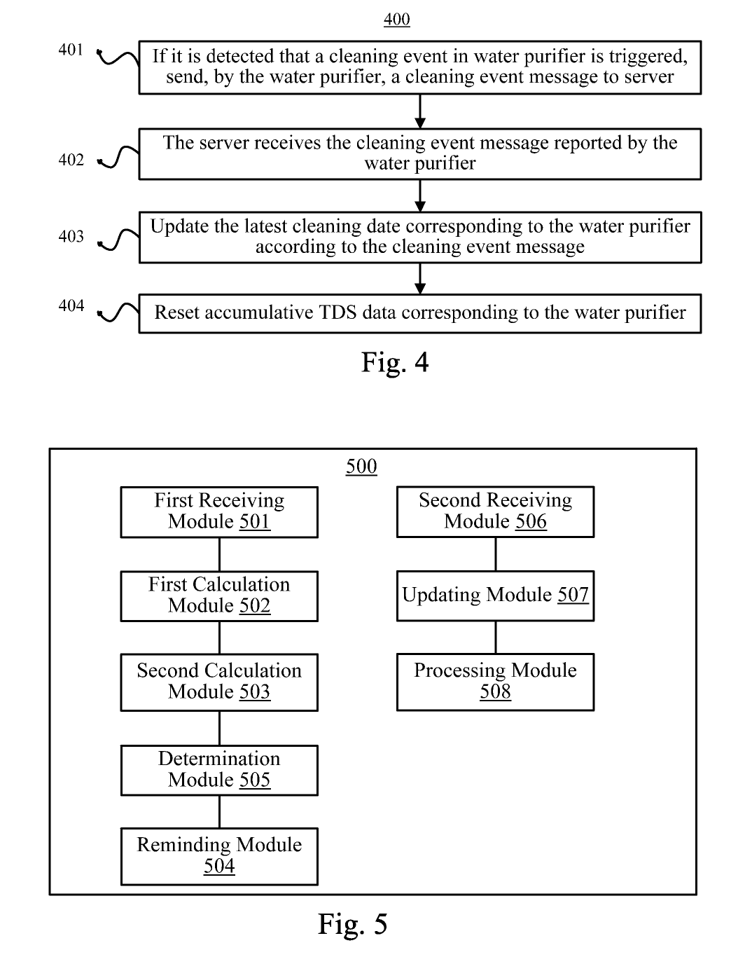

FIG. 4 is a flow chart showing a method 400 for reporting a cleaning event according to another exemplary embodiment of the present disclosure. As shown in FIG. 4, at 401, if it is detected that a cleaning event in a water purifier is triggered, a cleaning event message is sent by the water purifier to the server. For example, disassembling of the water purifier may trigger the cleaning event in a software program installed on the water purifier. The cleaning event message carries the identity of the water purifier.

At 402, the cleaning event message reported by the water purifier is received by the server.

At 403, the latest cleaning date corresponding to the water purifier is updated according to the cleaning event message. In some embodiments, the server inquires a cleaning record corresponding to the water purifier according to the identity of the water purifier. The cleaning record contains each cleaning date for the water purifier. The latest cleaning date in the cleaning record is changed to the current date.

At 404, the accumulative TDS data corresponding to the water purifier is reset. Specifically, the server inquires the accumulative TDS data corresponding to the water purifier in a corresponding relationship between the identity of the water purifier and the accumulative TDS data according to the identity of the water purifier, and resets the accumulative TDS data. As such, the water purifier begins accumulating TDS data again after cleaning

FIG. 5 is a block diagram of a device 500 for reminding a user about a smart water purifier according to an exemplary embodiment of the present disclosure. As shown in FIG. 5, the device 500 includes a first receiving module 501, a first calculation module 502, a second calculation module 503, and a reminding module 504.

The first receiving module 501 is configured to receive TDS data detected and reported by the water purifier after the water purifier performs water purification.

The first calculation module 502 is configured to calculate accumulative TDS data corresponding to the water purifier according to the TDS data received by the first receiving module 501. The accumulative TDS data represents a total increment of the TDS data from the water purifier after the latest cleaning.

The second calculation module 503 is configured to calculate a cleaning period of the water purifier under the current state according to a preset maximum cleaning period and the accumulative TDS data calculated by the first calculation module 502.

The reminding module 504 is configured to send a reminder message to a terminal associated with the water purifier to remind the user to clean the water purifier when the cleaning period calculated by the second calculation module 503 satisfies a preset condition.

In some embodiments, the first receiving module 501 includes a first receiving unit and a second receiving unit. The first receiving unit is configured to receive a water inlet TDS value and a water outlet TDS value detected and reported by the water purifier after the water purifier performs water purification. The second receiving unit is configured to receive a decrement TDS value reported by the water purifier. The decrement TDS value is calculated according to the water inlet TDS value and the water outlet TDS value detected after the water purifier performs water purification.

In some embodiments, as shown in FIG. 5, the device 500 further includes a determination module 505 configured to determine that the cleaning period satisfies a preset condition when a period between the current date and the latest cleaning date corresponding to the water purifier is greater than or equal to the cleaning period calculated by the second calculation module 503.

In some embodiments, as shown in FIG. 5, the device 500 further includes a second receiving module 506 and an updating module 507. The second receiving module 506 is configured to receive a cleaning event message reported by the water purifier. The updating module 507 is configured to update the latest cleaning date corresponding to the water purifier according to the cleaning event message received by the second receiving module 506.

In some embodiments, as shown in FIG. 5, the device 500 further includes a processing module 508 configured to reset the accumulative TDS data corresponding to the water purifier.

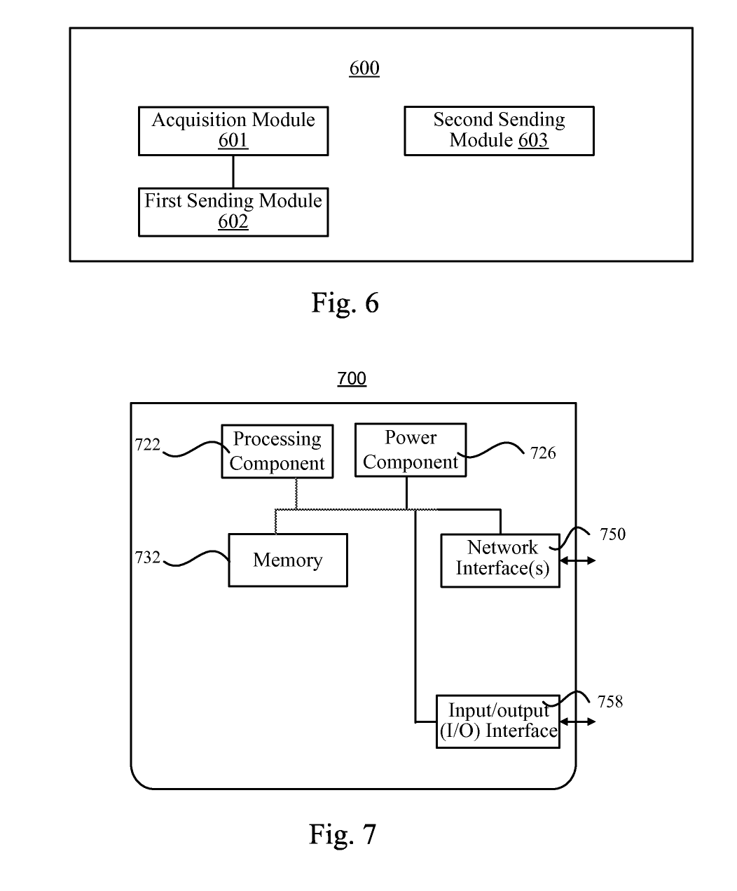

FIG. 6 is a block diagram of a device 600 for reminding a user about a smart water purifier according to another exemplary embodiment of the present disclosure. As shown in FIG. 6, the device 600 includes an acquisition module 601 and a first sending module 602. The acquisition module 601 is configured to acquire TDS data detected after the water purifier performs water purification. The first sending module 602 is configured to send the TDS data acquired by the acquisition module 601 to a server, so that the server sends a reminder message to a terminal associated with the water purifier according to the TDS data.

In some embodiments, the acquisition module 601 includes a first acquisition unit configured to acquire a water inlet TDS value and a water outlet TDS value detected after the water purifier performs water purification. The first sending module 602 includes a first sending unit configured to send the water inlet TDS value and the water outlet TDS value acquired by the first acquisition unit to the server.

In some embodiments, the acquisition module 601 includes a second acquisition unit and a calculation unit. The second acquisition unit is configured to acquire the water inlet TDS value and the water outlet TDS value detected after the water purifier performs water purification. The calculation unit is configured to calculate a decrement TDS value according to the water inlet TDS value and the water outlet TDS value. The first sending module 602 includes a second sending unit configured to send the decrement TDS value calculated by the calculation unit to the server.

In some embodiments, the device 600 further includes a second sending module 603 configured to send a cleaning event message to the server if it is detected that a cleaning event is triggered.

FIG. 7 is a block diagram of a device 700 for reminding a user about a smart water purifier according to an exemplary embodiment. For example, the device 700 may be implemented as a server. Referring to FIG. 7, the device 700 includes a processing component 722 that further includes one or more processors, and memory resources represented by a memory 732 for storing instructions executable by the processing component 722, such as application programs. The application programs stored in the memory 732 may include one or more modules each corresponding to a set of instructions. Further, the processing component 722 is configured to execute the instructions to perform methods consistent with embodiments of the present disclosure.

The device 700 further includes a power component 726 configured to perform power management of the device 700, wired or wireless network interface(s) 750 configured to connect the device 700 to a network, and an input/output (I/O) interface 758. The device 700 may operate based on an operating system stored in the memory 732, such as Windows Server™, Mac OS X™, Unix™, Linux™, FreeBSD™, or the like.

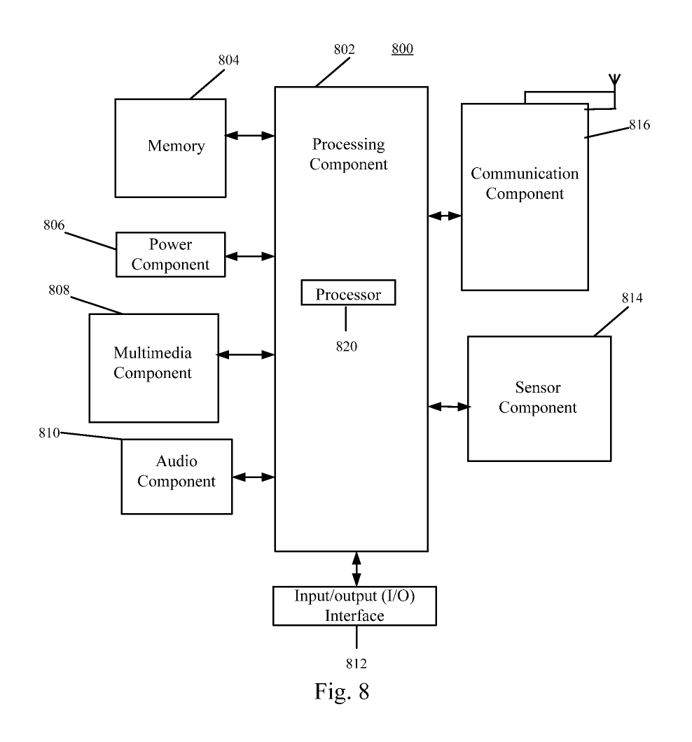

FIG. 8 is a block diagram of a device 800 for reminding a user about a smart water purifier according to another exemplary embodiment. For example, the device 800 may be a smart water purifier, a mobile phone, a computer, a digital broadcast terminal, a messaging device, a gaming console, a tablet, a medical device, exercise equipment, a personal digital assistant, or the like.

Referring to FIG. 8, the device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power in the device 800.

The multimedia component 808 includes a screen providing an output interface between the device 800 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, 3G, or 4G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed herein. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for reminding a user about a water purifier, comprising:
receiving total dissolved solids (TDS) data reported by the water purifier, the received TDS data being detected after the water purifier performs water purification;
updating accumulative TDS data corresponding to the water purifier according to the received TDS data, the accumulative TDS data reflecting an accumulation of total TDS data of the water purifier since a latest cleaning;
calculating a cleaning period of the water purifier according to the accumulative TDS data and a preset maximum cleaning period; and
sending, if the cleaning period satisfies a preset condition, a reminder message to a terminal associated with the water purifier to remind the user to clean the water purifier.

2. The method according to claim 1, wherein receiving the TDS data includes:
receiving a water inlet TDS value and a water outlet TDS value detected after the water purifier performs water purification; or
receiving a decrement TDS value calculated according to the water inlet TDS value and the water outlet TDS value.

3. The method according to claim 1, further comprising, before sending the reminder message:
determining whether the cleaning period satisfies the preset condition by determining whether a time period between a current date and a date of the latest cleaning corresponding to the water purifier is greater than or equal to the cleaning period.

4. The method according to claim 1, further comprising:
receiving a cleaning event message reported by the water purifier; and
updating a date of the latest cleaning corresponding to the water purifier according to the cleaning event message.

5. The method according to claim 4, further comprising, after updating the date of the latest cleaning:
resetting the accumulative TDS data corresponding to the water purifier.

6. A method for reminding a user about a water purifier, comprising:
acquiring, after the water purifier performs water purification, total dissolved solids (TDS) data; and
sending the TDS data to a server, so that the server sends a reminder message to a terminal associated with the water purifier according to the TDS data if a preset condition is satisfied.

7. The method according to claim 6, wherein:
acquiring the TDS data includes acquiring a water inlet TDS value and a water outlet TDS value detected after the water purifier performs water purification, and
sending the TDS data to the server includes sending the water inlet TDS value and the water outlet TDS value to the server.

8. The method according to claim 6, wherein:
acquiring the TDS data includes:
acquiring a water inlet TDS value and a water outlet TDS value detected after the water purifier performs water purification; and
calculating a decrement TDS value according to the water inlet TDS value and the water outlet TDS value, and
sending the TDS data to the server includes sending the decrement TDS data to the server.

9. The method according to claim 6, further comprising:
sending, if it is detected that a cleaning event is triggered in the water purifier, a cleaning event message to the server.

10. A device for reminding a user about a water purifier, comprising:
a processor; and
a non-transitory computer-readable storage medium storing instructions that, when executed by the processor, cause the processor to:
receive total dissolved solids (TDS) data reported by the water purifier, the received TDS data being detected after the water purifier performs water purification;
update accumulative TDS data corresponding to the water purifier according to the received TDS data, the accumulative TDS data reflecting an accumulation of total TDS data of the water purifier since a latest cleaning;
calculate a cleaning period of the water purifier according to the accumulative TDS data and a preset maximum cleaning period; and
send, if the cleaning period satisfies a preset condition, a reminder message to a terminal associated with the water purifier to remind the user to clean the water purifier.

11. The device according to claim 10, wherein the instructions further cause the processor to:
receive a water inlet TDS value and a water outlet TDS value detected after the water purifier performs water purification; or
receive a decrement TDS value calculated according to the water inlet TDS value and the water outlet TDS value.

12. The device according to claim 10, wherein the instructions further cause the processor to:
determine whether the cleaning period satisfies the preset condition by determining whether a time period between a current date and a date of the latest cleaning corresponding to the water purifier is greater than or equal to the cleaning period.

13. The device according to claim 10, wherein the instructions further cause the processor to:
receive a cleaning event message reported by the water purifier; and
update a date of the latest cleaning corresponding to the water purifier according to the cleaning event message.

14. The device according to claim 13, wherein the instructions further cause the processor to:
reset the accumulative TDS data corresponding to the water purifier.

15. A device for reminding a user about a water purifier, comprising:
a processor; and
a non-transitory computer-readable storage medium storing instructions that, when executed by the processor, cause the processor to:
acquire, after the water purifier performs water purification, total dissolved solids (TDS) data; and
send the TDS data to a server, so that the server sends a reminder message to a terminal associated with the water purifier according to the TDS data if a preset condition is satisfied.

16. The device according to claim 15, wherein the instructions further cause the processor to:
acquire a water inlet TDS value and a water outlet TDS value detected after the water purifier performs water purification, and
send the water inlet TDS value and the water outlet TDS value to the server.

17. The device according to claim 15, wherein the instructions further cause the processor to:
acquire a water inlet TDS value and a water outlet TDS value detected after the water purifier performs water purification;
calculate a decrement TDS value according to the water inlet TDS value and the water outlet TDS value; and
send the decrement TDS data to the server.

18. The device according to claim 15, wherein the instructions further cause the processor to:
send, if it is detected that a cleaning event is triggered in the water purifier, a cleaning event message to the server.
